(19) United States
(12) Patent Application Publication
(10) Pub. No.: US 2007/0285350 A1
(43) Pub. Date: Dec. 13, 2007

(54) Plasma display apparatus

(76) Inventors: Woo-Man Jeong, Suwon-si (KR); Se-Il Oh, Suwon-si (KR)

Correspondence Address: Robert E. Brushnell, Suite 300, 1522 K Street, N.W., Washington, DC, 20005, US

(21) Appl. No.: 11/723,332

(22) Filed: Mar. 19, 2007

(30) Foreign Application Priority Data
Apr. 12, 2006 (KR) 10-2006-0033201

(51) Int. Cl. G09G 3/10

(52) U.S. Cl. 345/41

(57) ABSTRACT

A plasma display apparatus is provided to reduce noise. The plasma display apparatus includes a plasma display panel, a chassis which is disposed behind the plasma display panel and supports the plasma display panel, a circuit unit which is disposed behind the chassis and drives the plasma display panel, a signal transmitting member which transmits electrical signals generated in the circuit unit to the plasma display panel, and a cover plate which covers a portion of the signal transmitting member. A penetrating hole is formed on the cover plate.

### CLAIM OF PRIORITY

This application makes reference to, incorporates the same herein, and claims all benefits accruing under 35 U.S.C. § 119 from an application for PLASMA DISPLAY APPARATUS earlier filed in the Korean Intellectual Property Office on the 12 Apr. 2006 and there duly assigned Serial No. 10-2006-0033201.

### BACKGROUND OF THE INVENTION

1. Field of the Invention

The present invention relates to a plasma display apparatus, and more particularly, to a plasma display apparatus including a plasma display panel, a chassis, a circuit unit, and a cover plate. The plasma display panel has capability of reducing noise generated during operation of the plasma display panel.

2. Description of the Related Art

Plasma display apparatuses using plasma display panels are flat panel display apparatuses that display images using a gas discharge phenomenon, and are considered to be next generation apparatuses due to excellent display properties such as high brightness, high contrast, lack of residual image, wide viewing angle, and a thin and large-scale display structure.

A plasma display apparatus usually includes a plasma display panel, a chassis disposed substantially parallel to the plasma display panel, a circuit unit installed behind the chassis to drive the plasma display panel, and a case containing the plasma display panel, the chassis, and the circuit unit.

In the plasma display apparatus, the circuit unit and the plasma display panel are electrically connected through a signal transmitting member such as a tape carrier package (TCP) and a chip on film (COF). The TCP is formed in a package such as a tape type package, in which a device such as a driver IC is mounted. In the COF, a device is mounted on a film which consists of a flexible printed circuit (FPC). The TCP and the COF have flexibility and a number of electronic devices may be mounted thereon, thereby reducing the size of the circuit unit. Therefore, the TCP and the COF are widely used.

When the TCP or the COF are operated, noise is, however, generated by the TCP or the COF. The noise can be heard by users, thereby the quality of the plasma display panels deteriorates. Therefore, a plasma display apparatus that has capability of reducing the noise is required to improve the quality of plasma display panel.

### SUMMARY OF THE INVENTION

The present invention provides a plasma display apparatus that reduces noise generated from a signal transmitting member, which connects a circuit unit to a plasma display panel to transmit signals to drive the plasma display panel.

According to an aspect of the present invention, there is provided a plasma display apparatus that includes a plasma display panel, a chassis coupled to a rear surface of the plasma display panel where the chassis supports the plasma display panel, a circuit unit arranged on a rear surface of the chassis where the circuit unit drives the plasma display panel to display an image, a signal transmitting member coupled to both of the plasma display panel and the circuit unit where the signal transmitting member transmits an electrical signal generated in the circuit unit to the plasma display panel and the signal transmitting member is arranged about an edge of the chassis, and a cover plate coupled to the chassis where the cover plate covers the signal transmitting member. The cover plate has a penetration hole.

The cover plate may include a base unit and a bending unit. The base unit is substantially parallel to the rear surface of the chassis, and the bending unit is coupled to the base unit and substantially parallel to a side surface of the chassis. The penetration hole may be formed on the bending unit. At least two penetration holes may be formed in the bending unit, and the penetration holes may be spaced apart from each other at a predetermined interval.

The penetration hole may be arranged on the bending unit in a manner that a portion of the signal transmitting member is exposed through the penetration hole. The signal transmitting member may include an electronic device that is covered by the base unit. The signal transmitting member may include at least two electronic devices, both of which are covered by the base unit.

The cover plate may further include a connection unit that connects the bending unit to the base unit. The cover plate may further include a reinforcing unit formed at one end of the base unit to strengthen the rigidity of the cover plate. The signal transmitting member may be a tape carrier package or a chip on film. The penetration hole may have a rectangular shape. The plasma display apparatus may further include a heat conducting member interposed between the cover plate and the signal transmitting member. The signal transmitting member may be supported by the chassis.

The plasma display panel may include a front panel, a rear panel spaced apart from the front panel and facing the front panel, a plurality of sustain electrodes formed on the front panel, a plurality of address electrodes formed on the rear panel where the address electrodes extends to cross the sustain electrodes, and a phosphor layer formed in the discharge cells. Intersections of the sustain electrodes and the address electrodes define discharge cells in a space formed between the front panel and the rear panel, and a discharge gas is filled in the discharge cells.

The circuit unit may include an address driving unit. The signal transmitting member is coupled to the address electrodes of the plasma display panel, and an electric signal generated in the address driving unit is transmitted to the address electrodes through the signal transmitting member.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view schematically illustrating a plasma display apparatus constructed as an embodiment of the present invention;

FIG. 2A is a cross-sectional view of the plasma display apparatus of FIG. 1 taken along a line II-II in FIG. 1;

FIG. 2B is an enlarged view of section A in FIG. 2A;

FIG. 3 is a detailed partial perspective view of a cover plate illustrated in FIG. 1;

FIG. 4 is an exploded perspective view of a plasma display panel of FIG. 1 constructed as an embodiment of the present invention;

FIG. 5 is a block diagram illustrating a circuit unit of plasma display apparatus of FIG. 1;

FIG. 6A is a photograph showing a result of noise measurement of a plasma display apparatus of a comparative example; and

FIG. 6B is a photograph showing a result of noise measurement of a plasma display apparatus constructed as an embodiment of the present invention.

### DETAILED DESCRIPTION OF THE INVENTION

Hereinafter, the present invention will be described more completely with reference to the accompanying drawings, in which exemplary embodiments of the invention are shown.

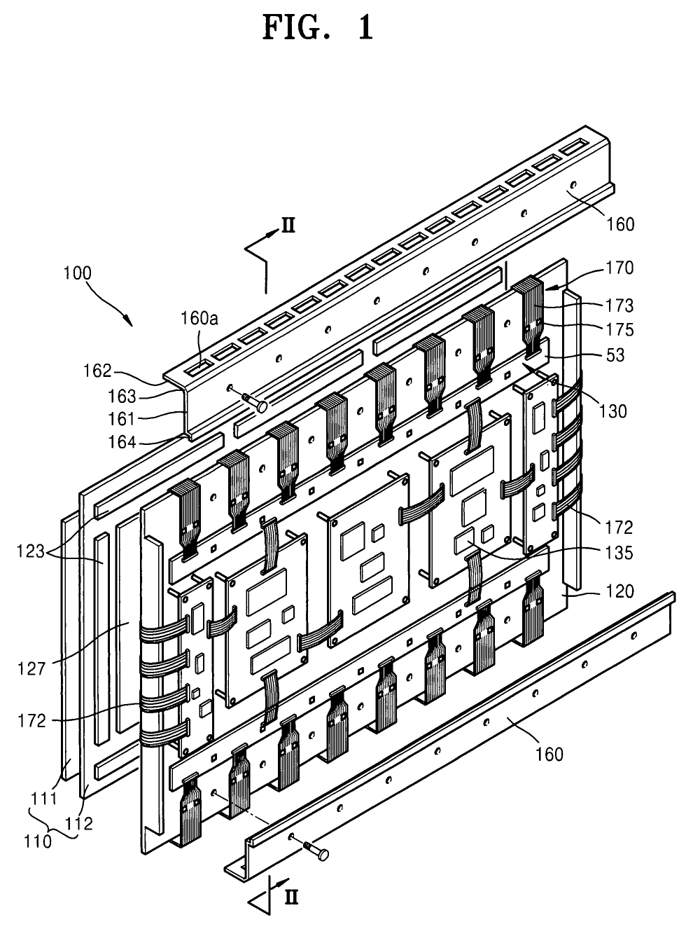

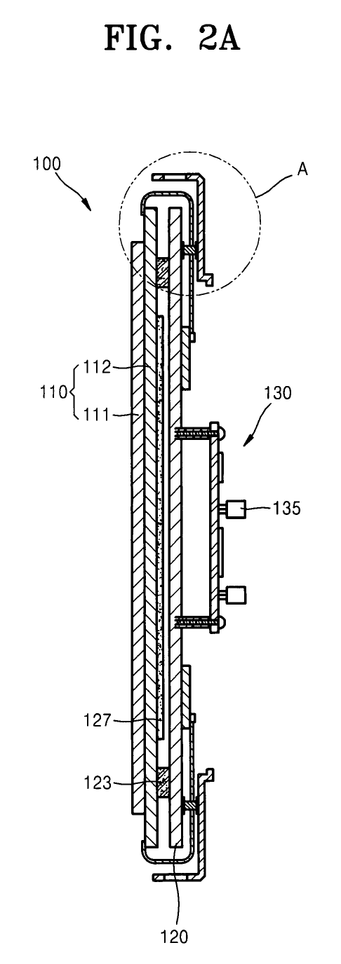

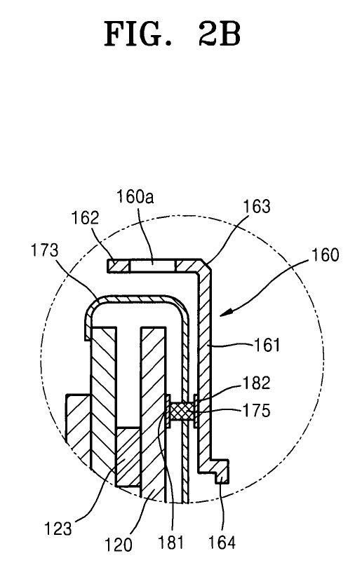

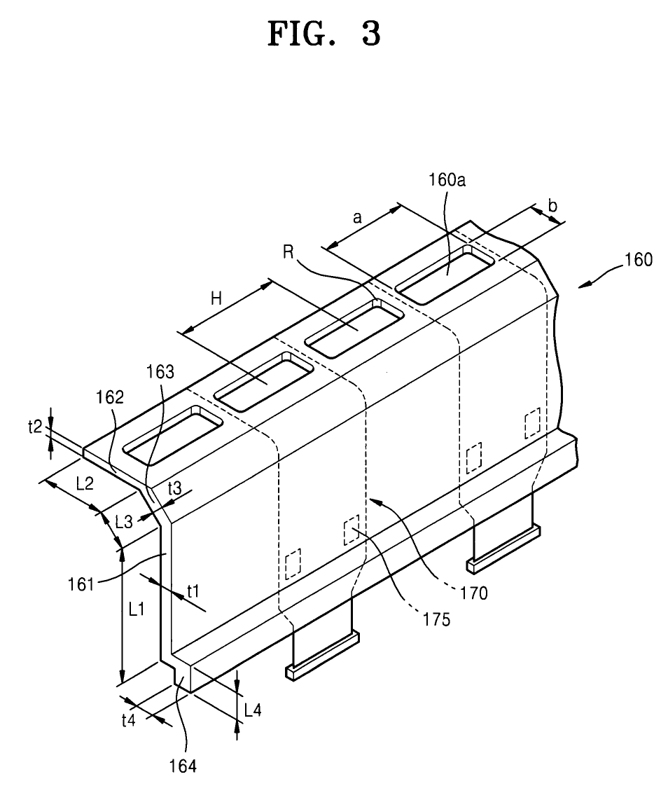

Plasma display apparatus 100 constructed as an embodiment of the present invention is illustrated in FIGS. 1 through 3. FIG. 1 is an exploded perspective view illustrating plasma display apparatus 100 constructed as an embodiment of the present invention. FIG. 2A is a cross-sectional view of plasma display apparatus 100 of FIG. 1 taken along a line II-II in FIG. 1. FIG. 2B is an enlarged view of section A in FIG. 2A. FIG. 3 is a detailed perspective view of a cover plate illustrated in FIG. 1.

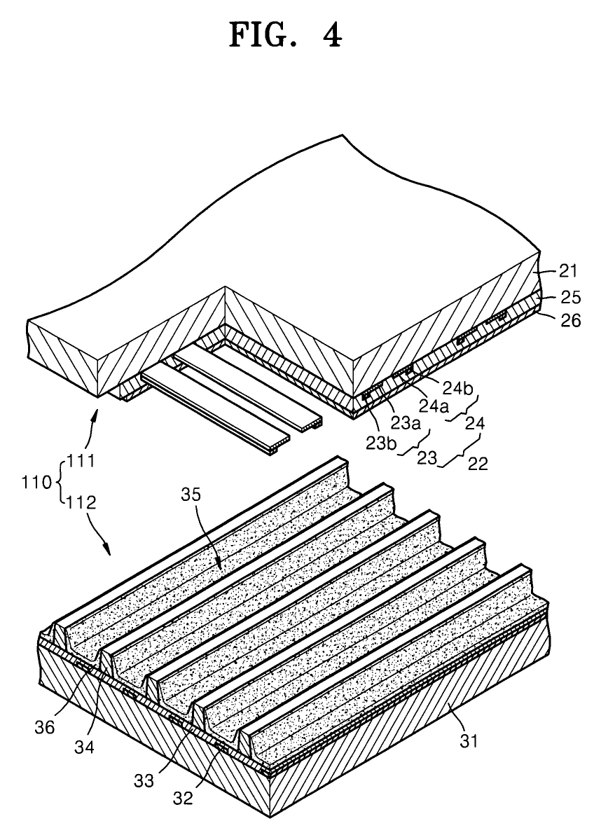

Referring to FIGS. 1 and 2, plasma display apparatus 100 includes plasma display panel 110, chassis 120, and circuit unit 130. An image is displayed on plasma display panel 110. Various types of plasma display panels can be selected for plasma display panel 110 of the present invention. Examples of the plasma display panel include an alternating current (AC) type plasma display panel that has a three-electrode surface discharge type structure as illustrated in FIG. 4.

Referring to FIG. 4, plasma display panel 110 includes front panel 111 and rear panel 112, which faces front panel 111 and spaced apart from front panel 111. Front panel 111 includes front substrate 21, sustain electrode 22, front dielectric layer 25, and protective film 26. Front substrate 21 is disposed at a front portion of front panel 111. Sustain electrode 22, which includes X-electrode 23 and Y-electrode 24, is disposed on a rear surface of front substrate 21. Front dielectric layer 25 covers sustain electrode 22, and protective film 26 is formed at the rear surface of front dielectric layer 25.

X-electrode 23 and Y-electrode 24 work as a sustain electrode and a scan electrode, respectively, and are spaced apart from each other by a discharge gap. X-electrode 23 includes X transparent electrode 23a and X bus electrode 23b that is connected to X transparent electrode 23a. Y-electrode 24 includes Y transparent electrode 24a and Y bus electrode 24b that is connected to Y transparent electrode 24a.

Rear panel 112 includes rear substrate 31, address electrode 32, rear dielectric layer 33, partitions 34, and phosphor layer 36. Rear substrate 31 is disposed on a rear portion of rear panel 112, address electrode 32 is formed on a front surface of rear substrate 31 and extends in a direction that crosses sustain electrode 22. Rear dielectric layer 33 covers address electrode 32. Partitions 34 are formed on rear dielectric layer 33 and define discharge cells 35. Phosphor layer 36 is disposed on each of discharge cells 35. Discharge cells 35 are filled with discharge gas.

Referring to FIG. 1, an image is displayed through front panel 111 of plasma display panel 110. Front panel 111 can be referred to as a front surface of plasma display panel 110. Chassis 120 is coupled to rear panel 112 of plasma display panel 110. Rear panel 112 can be referred to as a rear surface of plasma display panel 110. Herein, a side surface of plasma display panel is defined as a surface that is neither the front surface nor the rear surface of plasma display panel 110. The definitions of the front, rear and side surfaces are consistently applied to chassis 120. Therefore a front surface of chassis 120 faces the rear surface of plasma display panel 110, and a side surface of chassis 120 is a surface that is neither the front surface nor the rear surface of chassis 120.

Chassis 120 can be manufactured using casting or press processing. Chassis 120 is coupled to and supports plasma display panel 110 and circuit unit 130. Chassis 120 may be formed of a metal having high thermal conductivity, such as aluminum, in order to efficiently transfer heat, which is generated from plasma display panel 110, to the outside. However, in order to reduce the weight and manufacturing cost of the plasma display apparatus, chassis 120 can be made of plastic. Plasma display panel 110 can be attached to chassis 120 through double side tape 123.

Heat conducting sheet 127, which has high thermal conductivity, is interposed between plasma display panel 110 and chassis 120, so as to disperse heat partially generated from plasma display panel 110, and to transfer heat generated from plasma display panel 110 to chassis 120. Heat conducting sheet 127 can be made of a material including silicon or carbon.

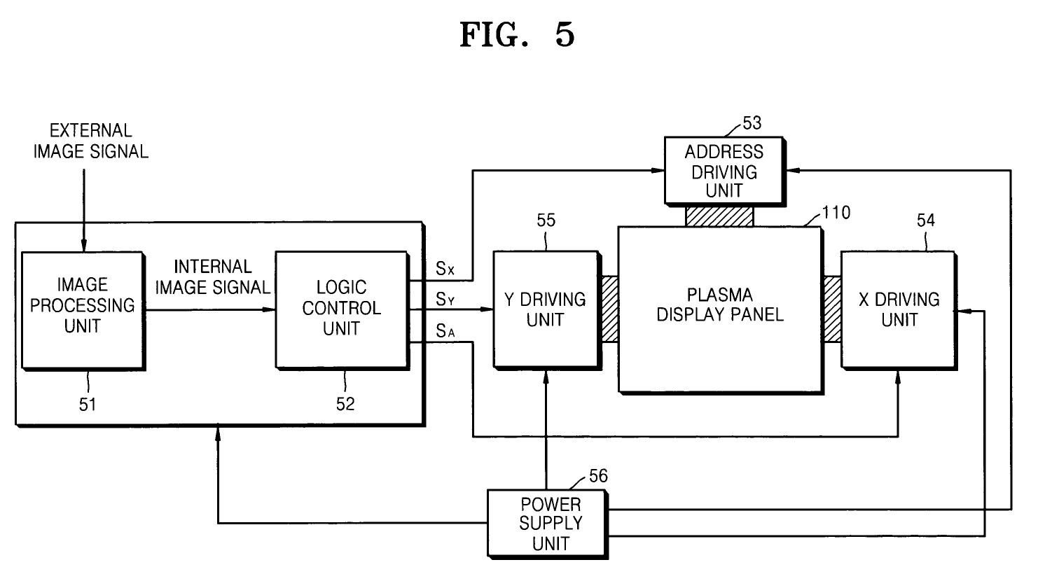

In addition, circuit unit 130, which is coupled to a rear surface of chassis 120, includes various kinds of electronic components 135 that are necessary to operate plasma display panel 110. As illustrated in FIG. 5, circuit unit 130 includes image processing unit 51, logic control unit 52, address driving unit 53, X driving unit 54, Y driving unit 55, and power supply unit 56.

In image processing unit 51, an external analogue image signal is converted into a digital signal which is used to generate internal image signals. For example, internal image signals can include eight bit red, green, and blue image signals, a clock signal, and vertical and horizontal sync signals.

In logic control unit 52, driving control signals such as address driving control signal S_{A}, Y driving control signal S_{Y}, and X driving control signal S_{X} are generated according to information contained in the internal image signals that are transferred from image processing unit 51. Address driving unit 53 receives address signal S_{A} from logic control unit 52, and generates address driving data signals. The address driving data signals are provided into address electrodes 32 (shown in FIG. 4). X driving unit 54 receives X driving control signal S_{X} from logic control unit 52, and generates X driving data signals. The X driving data signals are provided into X-electrodes 23 (shown in FIG. 4). Y driving unit 55 receives Y driving control signal S_{Y} from logic control unit 52, and generates Y driving data signals. The Y driving data signals are provided into Y-electrodes 24 (shown in FIG. 4). Power supply unit 56 supplies power that is necessary for operating image processing unit 51, logic control unit 52, address driving unit 53, X driving unit 54, and Y driving unit 55.

Referring to FIG. 1 again, circuit unit 130 transfers electrical signals to plasma display panel 110 using signal transmitting members. Examples of the signal transmitting members can include flexible printed cable (FPC), tape carrier package (TCP), and chip on film (COF).

In an embodiment of the present invention, a set of FPCs 172 is disposed on left and right edges of chassis 120 as a signal transmitting member, and a set of TCPs 170, each of which includes wiring unit 173 and two electronic devices 175, is disposed on upper and lower edges of chassis 120 as a signal transmitting member. In addition, as illustrated in FIG. 1, each TCP 170 is spaced apart from each other at a predetermined interval along the upper and lower edges of chassis 120.

Referring to FIGS. 1 through 3, cover plate 160 is disposed to partially or completely cover TCPs 170 on which electronic devices 175 are mounted. Cover plate 160 emits heat generated from electronic devices 175 to the outside, and prevent TCPs 170 from being damaged by any impact from the outside. Cover plate 160 is disposed at the upper and lower edges of chassis 120. The cover plates at the upper and lower edges of chassis 120 160 have substantially the same shape. Electronic device 175 can be any device that is coupled to the signal transmitting member. Electronic device 175 can be a device related to signal transmission, or can be a device related to other functions.

Cover plate 160 includes base unit 161 and bending unit 162. Base unit 161 is substantially parallel to a rear or front surface of chassis 120 in order to efficiently cover electronic devices 175 disposed on TCPs 170. Bending unit 162 is connected with base unit 161, and is bent from base unit 161 being substantially parallel to a side surface of chassis 120. Therefore, bending unit 162 and base unit 161 substantially form a right angle.

Cover plate 160 further include connection unit 163 which is interposed between base unit 161 and bending unit 162. Cover plate 160 may be manufactured by using various methods, for example, pressing or extruding method. If the cover plate is manufactured by using an extruding method, rigidity is improved and a manufacturing process is simplified. In an extruding process, however, if base unit 161 and bending unit 162 are directly connected, cracks may occur at a part at which base unit 161 and bending unit 162 are connected. Therefore, connection unit 163 may be further formed between base unit 161 and bending unit 162 to prevent the cracks. Connection unit 163 smoothly connects bending unit 162 to base unit 161 with a slope angle with respect to base unit 161 or bending unit 162.

Cover plate 160 further includes reinforcing unit 164. Reinforcing unit 164 is obtained by bending one end of base unit 161. Reinforcing unit 164 strengthens the rigidity of cover plates 160.

A plurality of penetration holes 160a, which are spaced apart from each other with a predetermined interval, are formed on bending unit 162. The penetration holes 160a have a rectangular shape. As shown in FIG. 3, the rectangle has a round vertex (R). However, penetration holes 160a may have various shapes such as a round shape, an elliptical shape, etc.

As shown in FIG. 3, each of penetration holes 160a is formed at a position of bending unit 162, below which one of TCPs 170 passes. Therefore, a portion of TCP is exposed through a penetration hole 160a. Each of penetration holes 160a one-to-one corresponds to one of TCPs 170. If each of TCPs 170 has one electronic device 175, it can be described as that each of penetration holes 160a one-to-one corresponds to one electronic device 175. If each of TCPs 170 has two electronic devices 175, it can be described as that each of penetration holes 160a one-to-one corresponds to two electronic devices 175. If the two electronic devices are spaced apart from each other, penetration hole 160a is positioned so that it may dissipate the noise generated by the vibration of electronic devices 175. For efficient dissipation of the noise, electronic devices 175 can be arranged symmetrically about penetration hole 160a. The symmetrical arrangement of the electronic devices means that the positions of electronic devices are symmetric about a center line that passes the center of the penetration hole and is drawn along a length direction of TCP (along L1, L2, and L3 shown in FIG. 3). If there are more than two electronic devices disposed on a TCP, the electronic devices can be symmetrically arranged about a penetration hole that corresponds to the TCP. Therefore, noise produced from the electronic devices and TCP can evenly disperse through the penetration hole. The arrangement of electronic devices 175, however, is not limited to the above mentioned symmetric arrangement.

The number of penetration holes that corresponds to a TCP can be greater than one. In this case, multiple penetration holes many-to-one corresponds to a TCP. Electronic devices disposed on a TCP can be arranged to maintain a symmetry with the penetration holes. Therefore, noise generated from the electronic devices and TCP can evenly disperse through the penetration holes.

In order to increase efficiency of heat radiation through cover plate 160, heat conducting member 182 is interposed between TCPs 170 and cover plate 160. Also, in order to radiate heat generated from electronic devices 175 through chassis 120, and to absorb external shock that can be applied to electronic devices 175, grease 181 is inserted between TCPs 170 and chassis 120. Grease 181 can be gel type adhesives. TCPs 170 are supported by chassis 120. If necessary, an additional bed (not illustrated) or a reinforcing unit (not illustrated) may be interposed between the TCPs 170 and the chassis 120.

Penetration holes 160a reduce noise generated by TCPs 170. The principles of reducing noise through penetration holes 160a will be described in detail. When electric signals transmit through TCPs 170, electronic devices 175 oscillate. The oscillation of electronic devices 175 produces vibration of wiring unit 173. Because cover plate 160, wiring unit 173, and chassis 120 are coupled together, irregular frictional sound is generated due to structural coupling of cover plate 160, wiring unit 173, and chassis 120. If the noise of frictional sound is not properly removed, the noise is reflected from cover plate 160 generating resonance, and diffuses to plasma display panel 110 or circuit unit 130.

In the embodiment of the present invention, the noise of irregular frictional sound resonating in a space between cover plate 160 and wiring unit 173 rapidly dissipates through penetration holes 160a, so as to rapidly reduce energy of the sound and thus to significantly reduce the noise.

Table 1 shows results obtained by measuring noise of a plasma display apparatus constructed according to the principles of the present invention and noise of a plasma display apparatus of Comparative Example. The plasma display apparatus of Comparative Example has the same structure as the plasma display apparatus of the present invention except that the plasma display apparatus of Comparative Example does not have penetration holes on a cover plate.

A detailed structure of cover plate 160 built for the plasma display panel of the present invention is described as follows. Referring to FIG. 3, the thickness t1 of base unit 161 is 5 mm, the thickness t2 of bending unit 162 is 1 mm, the thickness t3 of connection unit 163 is 1.5 mm, and the thickness t4 of reinforcing unit 164 is 3 mm. The length L1 of base unit 161 is 16 mm, the length L2 of bending unit 162 is 12.5 mm, the length L3 of connection unit 163 is 2.3 mm, and the length L4 of reinforcing unit 164 is 1.5 mm. Penetration holes 160a, having a rectangular shape, has four sides with opposite sides of equal length. The length of a longer side a is approximately 21 mm, and the length of a shorter side b is approximately 6.5 mm. The distance H between centers of two adjacent penetration holes 160a is approximately 26 mm. Penetration hole 160a has round vertex with a radius of about 1 mm. The total length of the cover plate 160 is 1094 mm, and the cover plate 160 has forty two penetration holes 160a.

Referring to Table 1, sound pressure level (SPL) is measured at a frequency band of 2.0 kHz, 2.5 kHz, 3.15 kHz, and total frequency area. The total frequency area is in a range of 50 kHz to 8 kHz. According to the result shown in Table 1, noise is reduced by approximately 45%, 34%, 2%, and 16% at a frequency band of 2.0 kHz, 2.5 kHz, 3.15 kHz, and a total frequency area, respectively.

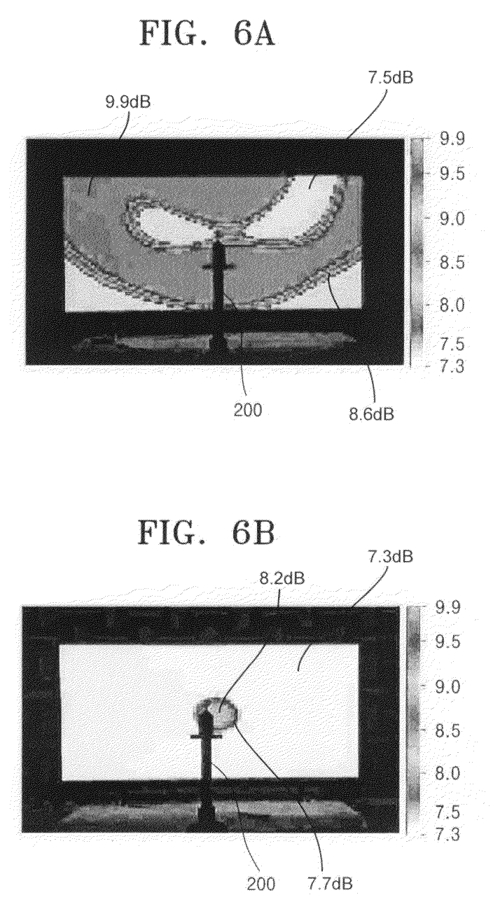

FIGS. 6A and 6B shows noise distributions on a two dimensional screen of plasma display panels. Noise camera 200 is installed in front of the plasma display panels, and two dimensional distribution of the noise, in the unit of dB, are measured for a plasma display panel of the present invention and for a plasma panel of Comparative Example. Each of the plasma display panels, which were used for the measurements, had 50 inches screen. The noise was measured at a frequency band from 1.778 kHz to 2.239 kHz. In FIGS. 6A and 6B, noise levels are drawn in colors with pink for the higher noise level of 9.9 dB and with white for the lower noise level of 7.3 dB. The noise levels are shown on the right side of the photos.

Referring to FIG. 6A, in the plasma display apparatus of the Comparative Example, noise is significantly high and broadly distributed over the screen. In particular, a region having a high noise level of 9.9 dB, which is illustrates in very dark color (pink) in the black and white photograph, is very wide.

Referring to FIG. 6B, in the plasma display apparatus of the present invention, noise region is formed around the center of the screen. In the rest of the region, noise is very low or does not exist. Therefore, the plasma display apparatus constructed as the embodiment of the present invention has a lower level of noise and a smaller noise diffusion region than the plasma display apparatus of the Comparative Example.

TABLE 1
Result of Noise Measurement

| | SPL(dB) of | |
|---|---|---|
| | Comparative | SPL(dB) of Embodiment of |
| | Example | the present invention |
| 2.0 kHz band | 21.0 | 11.5 |
| 2.5 kHz band | 11.8 | 7.8 |
| 3.15 kHz band | 10.7 | 10.5 |
| total frequency area | 25.2 | 21.2 |

As described above, in the plasma display apparatus of the present invention, noise generated due to the operation of signal transmitting members is reduced through the penetration holes formed on the cover plate and thus the quality of the plasma display apparatus is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display apparatus comprising:
a plasma display panel;
a chassis coupled to a rear surface of the plasma display panel, the chassis supporting the plasma display panel;
a circuit unit arranged on a rear surface of the chassis, the circuit unit driving the plasma display panel to display an image;
a signal transmitting member coupled to both of the plasma display panel and the circuit unit, the signal transmitting member transmitting an electrical signal generated in the circuit unit to the plasma display panel, an end of the signal transmitting member arranged about an edge of the chassis; and
a cover plate coupled to the chassis, the cover plate covering the signal transmitting member, the cover plate having a penetration hole.

2. The plasma display apparatus of claim 1, comprised of the cover plate comprising a base unit and a bending unit, the base unit being substantially parallel to the rear surface of the chassis, the bending unit being coupled to the base unit and substantially parallel to a side surface of the chassis.

3. The plasma display apparatus of claim 2, wherein the penetration hole is formed on the bending unit.

4. The plasma display apparatus of claim 2, wherein at least two penetration holes are formed in the bending unit, the penetration holes being spaced apart from each other at a predetermined interval.

5. The plasma display apparatus of claim 3, comprised of the penetration hole being arranged on the bending unit in a manner that a portion of the signal transmitting member is exposed through the penetration hole.

6. The plasma display apparatus of claim 3, wherein the signal transmitting member includes an electronic device, which is covered by the base unit.

7. The plasma display apparatus of claim 3, wherein the signal transmitting member includes at least two electronic devices, which are covered by the base unit.

8. The plasma display apparatus of claim 1, comprised of the cover plate further comprising a connection unit connecting the bending unit to the base unit.

9. The plasma display apparatus of claim 1, comprised of the cover plate further comprising a reinforcing unit formed at one end of the base unit to strengthen the rigidity of the cover plate.

10. The plasma display apparatus of claim 1, comprised of the signal transmitting member including one selected from the group consisting of a tape carrier package and a chip on film.

11. The plasma display apparatus of claim 1, comprised of the penetration hole having a rectangular shape.

12. The plasma display apparatus of claim 1, further comprising a heat conducting member interposed between the cover plate and the signal transmitting member.

13. The plasma display apparatus of claim 1, comprised of the signal transmitting member being supported by the chassis.

14. The plasma display apparatus of claim 1, wherein the plasma display panel comprises:
a front substrate;
a rear substrate spaced apart from the front substrate and facing the front substrate;
a plurality of sustain electrodes formed on the front substrate;
a plurality of address electrodes formed on the rear substrate, the address electrodes extending to cross the sustain electrodes, intersections of the sustain electrodes and the address electrodes defining discharge cells in a space formed between the front substrate and the rear substrate;
a phosphor layer formed in the discharge cells; and
a discharge gas filled in the discharge cells.

15. The plasma display apparatus of claim 14, wherein the circuit unit includes an address driving unit, the signal transmitting member is coupled to the address electrodes of the plasma display panel, and a driving data signal generated in the address driving unit is transmitted to the address electrodes through the signal transmitting member.

16. A plasma display apparatus comprising:
a plasma display panel;
a chassis coupled to a rear surface of the plasma display panel, the chassis supporting the plasma display panel;
a circuit unit arranged on a rear surface of the chassis, the circuit unit driving the plasma display panel to display an image; and
a cover plate coupled to the chassis, the cover plate comprising:
a base unit being substantially parallel to the rear surface of the chassis; and
a bending unit being coupled to the base unit and substantially parallel to a side surface of the chassis, the bending unit having a penetration hole.

17. The plasma display apparatus of claim 16, further comprising:
a signal transmitting member disposed between the chassis and the cover plate, the signal transmitting member transmitting an electrical signal generated in the circuit unit to the plasma display panel, an end of the signal transmitting member arranged about an edge of the chassis.

18. The plasma display apparatus of claim 17, comprised of the penetration hole being arranged on the bending unit in a manner that a portion of the signal transmitting member is exposed through the penetration hole.

19. The plasma display apparatus of claim 16, comprised of the cover plate further comprising a connection unit connecting the bending unit to the base unit.
